(19) United States
(12) Patent Application Publication
(10) Pub. No.: US 2006/0076387 A1
(43) Pub. Date: Apr. 13, 2006

(54) Joining method and apparatus

(76) Inventors: Naoaki Ogure, Tokyo (JP); Yusuke Chikamori, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/235,178

(22) Filed: Sep. 27, 2005

(30) Foreign Application Priority Data
Sep. 28, 2004 (JP) 281535/2004

(51) Int. Cl. A47J 36/02

(52) U.S. Cl. 228/101

(57) ABSTRACT

A joining method, which can perform high quality joining at a practical cost, without applying a high temperature or a great compressive load, and without introducing a joining inhibitor, such as a metal oxide, between members to be joined, is provided.

This joining method has a joining step of bonding together a plurality of members W₁, W₂, which are to be joined, metallurgically in a solid phase state, and comprises a contact step of bringing a liquid organic acid L into contact with surfaces to be joined of the members W₁, W₂ to be joined. By this measure, a non-metallic substance, such as an oxide, covering the surfaces to be joined of the members W₁, W₂ to be joined is reduced, and thereby converted into a water-soluble complex for removal, whereby metals as materials are exposed at the surfaces to be joined of the members W₁, W₂ to be joined. Such surfaces to be joined are contacted with each other, whereby the members W₁, W₂ to be joined can be joined together at a low contact surface pressure and a low temperature.

### BACKGROUND OF THE INVENTION

This invention relates to a joining method and apparatus for contacting members, which are to be joined, with each other to cause their metallurgical joining, thereby integrating the members to be joined.

In a manufacturing process, especially a packaging process, for a semiconductor device, solder which contains lead has been frequently used to join contacts together. However, direct joining using no solder is desired in order to lessen a burden on the environment, and further to reduce costs by cutting down on materials and steps.

Table 1 shows conventional methods for joining members to be joined, the members comprising metals or the like, into contact with each other, unchanged as solids, without using solder, thereby binding them metallurgically for integration.

TABLE 1

| | |
|---|---|
| Type of joining | Main mechanism · principle · feature of joining |
| Pressure welding | Exposure and mutual contact of clean metal |
| | surfaces by plastic deformation |
| Diffusion joining | Atomic diffusion between members due to high |
| | temperature |
| Surface activation | Cleaning and activation of surfaces of members |
| joining | to be joined, upon irradiation with ions |
| Vacuum joining | Contact of clean metal surfaces in vacuum |

Among the conventional joining methods shown in Table 1, pressure welding brings clean metal surfaces into contact with each other, thus requiring that members to be joined be plastically deformed on a large scale. In diffusion joining, members to be joined need to be kept at a high temperature in order to cause mutual diffusion of atoms. The use of these processes, therefore, poses the problem of strain, distortion or material deterioration of the members to be joined, due to large-scale plastic deformation or a high temperature.

With surface activation joining and vacuum joining, on the other hand, members to be joined need to be placed in a vacuum environment. This requires a large-scale apparatus, incurs equipment costs, and tends to render the joining step complicated and tiresome.

As a means of purifying the surface in an atmospheric environment, acid pickling methods exemplified in Table 2 have hitherto been performed.

TABLE 2

| Subject | | |
|---|---|---|
| material | Type · concentration of acid | Temperature |
| Ferrous | 10% Sulfuric acid, | 70° C. |
| material-based | 15% Hydrochloric acid, etc. | |
| Stainless | Fluoronitric acid, etc. | |
| steel-based | | |
| Aluminum-based | 38 g/L Sodium phosphate, | 90° C. |
| | 25 g/L Sodium hydroxide, etc. | |
| Copper-based | 20 vol % Sulfuric acid, | 70° C. |
| | Sulfuric acid · nitric acid | |
| | (mixture), etc. | |

Acid pickling by the conventional methods shown in Table 2 is mainly aimed at bringing a metal into contact with an inorganic acid (mineral acid), thereby peeling an oxide film normally present on the surface of the metal, as shown in FIG. 1(a), and also passiyating the surface of the metal. Desirably, the acid used and the metal itself do not react with each other. Normally, however, a very thin passivation layer, such as an oxide film, is newly formed on the surface of the metal as a result of surface corrosion by acid pickling. For example, when copper is acid pickled by the method of Table 2, it is observed that a surface film of copper oxide with a thickness of the order of 10 nm is formed, as shown in FIG. 1(b).

It is also observed that Cu₂O remains on the surface of copper after diluted hydrofluoric acid treatment which may be performed after formation of copper interconnecting of a semiconductor. Upon joining of metal surfaces cleaned by such a method, therefore, metal oxides are interposed between these metal surfaces, posing the problem that sufficient joining strength is not obtained.

Apart from the above-described removal of the surface film by acid pickling using a liquid acid, a dry method has been published which comprises bringing a reactive organic gas into contact with the surface of a copper oxide film to cause a reaction, thereby removing the film (Akitomo Koide et al., abstracts of lectures at the 47th Applied Physics-Related Joint Lecture Meeting (2000.3) 30 P-YA-16).

The following formulas (1) and (2) are considered to represent reaction formulas by this method [complexing and elimination of copper oxide]:
(presence of 0₂)Cu₂O+2H(hfac)→Cu(hfac)₂⇑+Cu+H₂O (1)
(presence of 0₂)CuO+2H(hfac)→Cu(hfac)₂⇑+H₂O (2)

Hereinabove, H(hfac) and Cu(hfac)₂ are both in a gaseous state. That is, copper-(I) oxide and copper-(II) oxide are each complexed into Cu(hfac)₂ by the reactions of the formulas (1) and (2) for dissociation and dissipation.

FIG. 2 shows the removal rate of the surface of a copper substrate which is made public in Non-patent Document 1 (T: substrate temperature K). This diagram shows the results of the simultaneous supply of an oxidizing gas O₂ for converting the surface of copper into an oxide, in addition to the supply of H(hfac). As shown in FIG. 2, the removal rate of the copper surface markedly increases with a rise in the temperature and, when the substrate temperature falls to nearly the room temperature, takes only a very low value. From FIG. 2, the removal rate R can be described as the equation (3) with respect to a certain temperature range:

$$R = {R}_{0} exp ( - \frac{8704.5}{T} ) \qquad ( 3 )$$

where R₀ denotes a constant independent of the temperature.

Assuming that the Arrhenius' relationship of FIG. 2 can be applied up to the room temperature side, and if T=300K is substituted into the equation (3), R=3.52×10⁻⁴ nm/min, a very low value. This means that the surface is retained in a substantially constant state, and the film cannot be removed. Furthermore, H(hfac) is the same as a by-product gas produced during CVD process of copper, and is remarkably expensive.

To carry out the removal of the surface film by the dry gas shown in FIG. 2, the use of the expensive organic gas is required, and raising the copper surface temperature roughly to 250° C. or higher is necessary to cause the significant removal of the surface film. This is likely to damage the surrounding insulating film, for example. Thus, this method is judged to be unsuitable for the production of a semiconductor device.

Moreover, if the above-mentioned joining method is used in a semiconductor manufacturing process, a compound film, such as a very thin oxide film, has been shown to exert an extremely adverse influence at the time of joining. For example, an oxide film is necessarily formed on the surface of aluminum, even if a surface treatment as a common practice is applied. To carry out cold pressure welding effectively under these circumstances, a compressive reduction of 40% or more is regarded as necessary. This is a showing that a great compressive load is necessary for destroying the oxide films present on the surfaces of members to be joined, and bringing the metals into direct contact with each other, thereby joining them together. Such a great compressive load is inappropriate, because it deforms the members to be joined, on a large scale, and is thus likely to impair the function of the resulting product easily.

### SUMMARY OF THE INVENTION

The present invention has been accomplished in light of the above-described circumstances. It is an object of the invention to provide a joining method and a joining apparatus which can perform high quality joining at a practical cost, without applying a high temperature or a great compressive load, and without interposing a metal oxide or the like between members to be joined.

### BRIEF DESCRIPTION OF THE DRAWINGS

FIGS. 1(a) and 1(b) are views schematically showing (a) the step of acid pickling by a conventional method, and (b) a state after the acid pickling;

FIG. 2 is a diagram showing the removal rate of the surface of a copper substrate by a conventional method;

FIGS. 3(a) to 3(c) are views showing the steps of a joining method according to an embodiment of the present invention;

FIGS. 4(a) to 4(c) are views showing the steps of a joining method according to another embodiment of the present invention;

FIG. 5 is a view showing a first embodiment of a joining apparatus for performing the joining method of the present invention;

FIG. 6 is a view showing essential parts of the joining apparatus of FIG. 5;

FIGS. 7(a) and 7(b) are views schematically showing the step of cleaning by the present invention, and a state after the cleaning, respectively;

FIG. 8 is a view showing another embodiment of a cleaning chamber of the joining apparatus;

FIGS. 9(a) to 9(c) are views showing the steps of a joining method according to still another embodiment of the present invention;

FIG. 10 is a view showing another embodiment of the joining apparatus for performing the joining method of the present invention;

FIG. 11 is a view showing the state of joining and shear rupture test specimens in an example of the present invention; and

FIG. 12 is a graph showing the relationship between a contact surface pressure P during joining and shear joining strength p after joining in the example of the present invention.

### DETAILED DESCRIPTION OF THE INVENTION

A preferred joining method for attaining the aforementioned object is a joining method which bonds together a plurality of members, which are to be joined, metallurgically in a solid phase state, and comprises a contact step of mating a liquid organic acid into contact with at least a pair of surfaces to be joined of the members to be joined, and a step of bringing the surfaces to be joined into contact with each other, thereby joining the members to be joined.

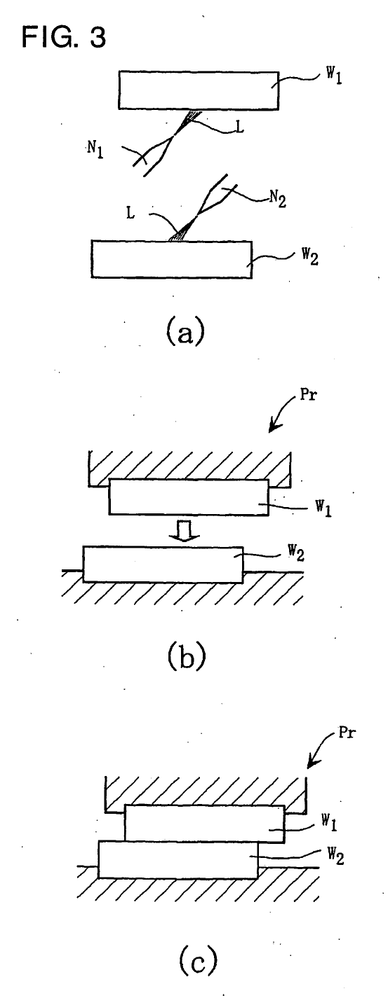

With reference to FIGS. 3(a) to 3(c), illustrating the above joining method, a liquid organic acid (an organic acid liquid) L is jetted from jet nozzles N₁ and N₂ at surfaces to be joined of members W₁ and W₂ to be joined, as in FIG. 3(a). Then, the organic acid liquid L is removed or dried as desired, and a predetermined pressure welding device Pr operates, as in FIG. 3(b), to bring the members to be joined into intimate contact with each other and join them under the contact surface pressure needed, as in FIG. 3(c).

In the present embodiment, the organic acid is contacted with the surface to be joined of the member to be joined. By this treatment, a non-metallic substance, such as an oxide, covering the surface to be joined is reduced, and thereby converted into a water-soluble complex for removal, with the metal as the material being exposed at the surface to be joined. In this manner, the organic acid is contacted with the surface to be joined, so that the members to be joined can be joined together at a low contact surface pressure and a low temperature. For the joining step, a phenomenon, such as adhesion or sintering of the metals, and/or diffusion of constituent atoms between the metals, can be adopted, as appropriate.

Reduction of the oxide on the surface to be joined is easily carried out by using the organic acid in liquid form. This is because the contact with the liquid organic acid promptly causes, for example, reduction of the metal oxide film, and change into the water-soluble complex, as compared with an organic acid in a gaseous or solid phase. This is attributed to the fact that as in a general electrochemical reaction, the reducing action of the organic acid in the liquid phase state is markedly potent as compared with the organic acid in the gaseous or solid phase state.

In the joining method of the present invention, a metal-containing material other than the member to be joined can be interposed between the members to be joined. According to this embodiment, if the essential joining properties of the members to be joined are low, for example, the joining properties can be improved by inserting a metal with good diffusibility between the members to be joined. As the other metal-containing material, it is useful to apply, for example, a simple metal such as a metal foil, or a material such as metal containing nanoparticles coated and protected with organic matter or the like.

In the joining method of the present invention, the member to be joined can be a material containing ceramic or plastic. For example, an ordinary industrial ceramic material contains a metallic additive, such as Co or Ni, to facilitate sintering. Such a metal chiefly plays the role of a binder for a sintered ceramic. The organic acid is caused to act on the metallic additive present on the surface of the ceramic material to clean the surface of the metallic additive, followed by joining, whereby such a ceramic material can be joined to other metal, ceramic or plastic.

As the member to be joined, moreover, a composite material containing ceramic or plastic and a metal can be used. With a non-metallic material such as ceramic or plastic, surface metallizing is performed to coat the surface of the non-metallic material with a metal layer, as desired. The organic acid is caused to act on the coating metal layer to clean the surface of the coating metal layer, followed by joining, whereby such a ceramic material can be joined to other metal, ceramic or plastic. Among the conventional method in practical use for surface metallizing of ceramics are so-called liquid phase processes (Mo—Mn method, copper oxide method, mercury process, Ni—W method, electroless plating method, etc.), and dry methods such as sputtering film deposition, in addition to a glazing method using a paste. As the method for surface metallizing of plastics, at least the electroless plating method or the sputtering film deposition can be put to practical use.

In the joining method of the present invention, one or more acids selected from the group consisting of succinic acid, malonic acid, phenol, oxalic acid, acetic acid, tartaric acid, citric acid, maleic acid, salicylic acid, formic acid, and other long-chain carboxylic acids can be used as the above-mentioned organic acid. These organic acids basically have a strong reducing capability of an oxide or the like on the surface of a metal such as Cu.

In the joining method of the present invention, the metal can consist essentially of one or more of a noble metal, nickel, copper, iron, titanium and aluminum. The surface of any such metallic material is often coated with a very thin oxide film, and such an oxide film is easily reduced with the organic acid. As a result, a clean metal surface is easily exposed. If this surface is created as a surface to be joined, joining itself occurs with ease.

In the joining method of the present invention, the temperature of the member to be joined in the aforementioned joining step can be rendered 400° C. or lower. If the temperature of the member to be joined is higher than 400° C., excessive deformation due to decreased strength may often occur in a part of the member to be joined, which has been placed under a contact surface pressure, during the joining process. Alternatively, material deterioration associated with a change in the metal property due to a high temperature may often take place. Hence, it is advisable to perform joining, with the temperature of the member to be joined being kept at 400° C. or lower.

In the joining method of the present invention, copper or a copper alloy can be used as at least one of the materials for the members to be joined, and formic acid can be used as the organic acid.

In the joining method of the present invention, the duration of the contact with the organic acid may be about 1.0 s or more, but less than about 100 s. If the time of contact between the member to be joined and the organic acid is less than 0.1 s, this period of time falls short of the time necessary for reducing the oxide film on the surface of the member to be joined, thus making it impossible to remove the oxide film. If the contact time is 100 s or more, the time required for the step is so long that the disadvantage of inefficiency is caused. Thus, the time of contact between the member to be joined and the organic acid is 0.1 s or more, but less than 100 s.

In the joining method of the present invention, any one or more of methods, such as coating, spraying, jetting, dropwise addition, printing, or spin coating of the organic acid, and dipping in the organic acid, can be used as a means of bringing the surface of the member to be joined into contact with the organic acid. These contact methods are means hitherto put to practical use as methods of surface coating, and can be used, as appropriate, in accordance with the situation of the practice of the invention.

In the joining method of the present invention, the organic acid can be brought into contact with a plurality of the members to be joined, with these members being held in predetermined relative positional relationship.

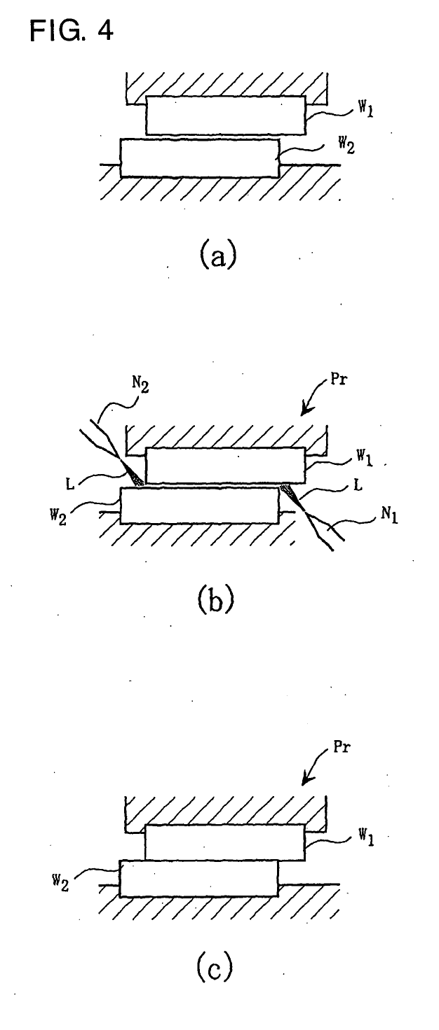

The predetermined relative positional relationship herein refers to positional relationship in which the members to be joined, W₁ and W₂, are positioned opposed to each other for joining, as shown, for example, in FIG. 4(a). In this state, the organic acid liquid L is jetted from the jet nozzles N₁ and N₂ and contacted with the members W₁ and W₂, as shown in FIG. 4(b). By this measure, pressure welding can be performed with minimal contamination of the surface or minimal deterioration, without the need for a long distance moving, mounting, or positioning of the members to be joined on the pressure welding device Pr after cleaning. This method is preferred particularly, for example, when the members to be joined, W₁ and W₂, are complicated in shape, a relatively long time is required for a step such as transportation.

If the cleaning step and the pressure welding step are performed by the same device, as mentioned above, there might be disadvantages such as equipment cost and efficiency, in comparison with a case where they are performed by different devices. Thus, it is necessary to select one of the two concepts, depending on the shape and material of the member to be joined, the characteristics of the finally targeted product, and so on.

In the joining method of the present invention, the main substance of the organic acid can be in a solid phase at the ordinary temperature, and the organic acid can be brought into contact with the member to be joined, with the organic acid being dispersed or dissolved in a pertinent liquid dispersing medium or solvent, such as alcohol or water. If the organic acid which is solid at the room temperature is used, the organic acid is used dispersed or dissolved in a liquid dispersing medium or solvent, such as alcohol or water, whereby a predetermined surface treatment effect can be obtained.

In the joining method of the present invention, the above-mentioned metal-containing material can include metal nanoparticles. Thus, the material including such metal nanoparticles can be metallurgically bonded in the solid phase state. The metal nanoparticles are preferably complex nanoparticles having a metal core whose periphery is coated with organic matter. Advisably, the organic acid is brought into contact with the complex nanoparticles prior to the joining step.

In the above embodiment, the complex nanoparticles can be complex metallic nanoparticles having a metal core whose periphery is coated with organic matter.

If the complex metal nanoparticles having a metal core whose periphery is coated with organic matter is used, the organic acid is preferably formic acid. Formic acid has a very simple molecular formula, HCOOH, and has high acidity among organic acids (most carboxylic acids have an acidity constant Ka in the 10⁻⁵ range, while the acidity constant Ka of formic acid is 1.77×10⁻⁴). Thus, formic acid is potent in its action of reducing the surface oxide film.

Another embodiment of the present invention is a joined structure produced by joining according to the joining method of the present invention.

Still another embodiment of the present invention is a joining apparatus for metallurgically joining together a plurality of members to be joined, with the members being in a solid phase state, the joining apparatus comprising surface cleaning means for bringing a liquid organic acid into contact with surfaces to be joined of the members to be joined, and joining means for joining the cleaned surfaces to be joined, with these surfaces in contact with each other.

According to the present invention, there can be provided a joining method and a joining apparatus which can perform joining at a practical cost, without applying a high temperature or a great compressive load.

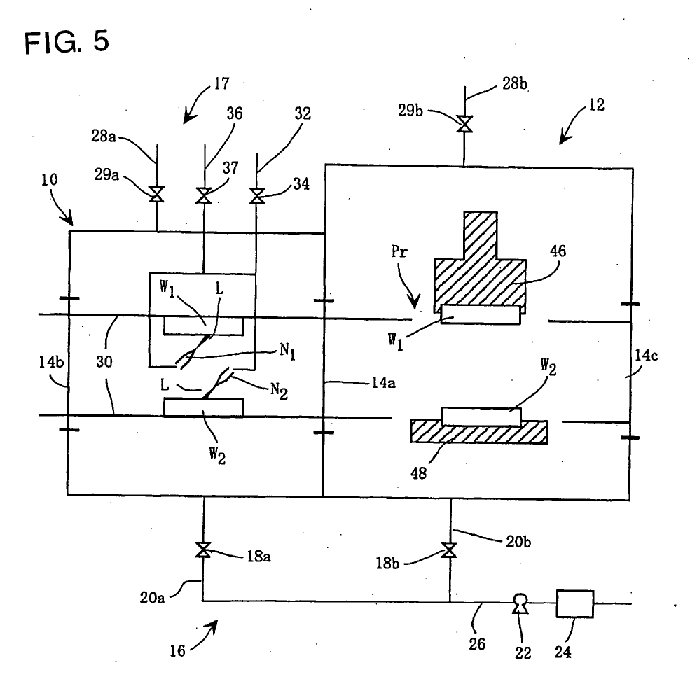

The method and apparatus of the present invention will be described, in which the step of joining members to be joined, the members comprising copper, is taken as an example. FIG. 5 is a view illustrating a first embodiment of a joining apparatus for performing the joining method of the present invention. The joining apparatus has two treatment chambers provided adjacently via a gate 14a, the treatment chambers being a cleaning chamber 10 for cleaning a surface, and a pressure welding chamber 12 for performing joining. These treatment chambers 10 and 12 are each formed in an airtight manner, and are provided with an exhaust means 16 and an atmospheric gas supply means 17 for adjusting an atmosphere. In this embodiment, the exhaust means 16 is furnished with exhaust pipings 20a, 20b having opening and closing valves 18a, 18b, and a main exhaust piping 26 having an exhaust pump 22 and a exhaust hazard eliminating device 24. The atmospheric gas supply means 17 is furnished with an atmospheric gas (concurrently serving as a dry gas) supply piping 28 communicating with an atmospheric gas source (not shown), and an opening and closing valve 29 for opening and closing the atmospheric gas supply piping 28.

The cleaning chamber 10 is provided with a gate 14b connected to a preparatory chamber (not shown) for bringing in the members W₁, W₂ to be joined, while the pressure welding chamber 12 is provided with a gate 14c for bringing outward the joined members. To transport the members W₁, W₂ to be joined through these treatment chambers, a transport means comprising trolleys (not shown) and rails 30, for example, is provided, but its details are omitted herein.

The cleaning chamber 10 is provided with the jet nozzles N₁, N₂ for jetting the organic acid liquid L at the opposed surfaces of the members W₁, W₂ to be joined which are held by the transport means so as to be opposed vertically. In the illustrated embodiment, one pencil-shaped jet nozzle N₁ and the other pencil-shaped jet nozzle N₂ are arranged vertically. However, a plurality of the jet nozzles N₁, N₂ may be provided, and the jet nozzles N₁, N₂ may be of a suitable type which can sprinkle a small amount of liquid widely, such as a rod-shaped one or an annular one having an opening formed therein. An organic acid liquid supply piping 32 is provided for connecting the jet nozzles N₁, N₂ to an organic acid liquid supply source (not shown) via an opening and closing valve 34.

A drying gas supply piping 36, which jets an inert gas, such as nitrogen, or warm air such as air, as a drying gas at the cleaned surfaces of the members W₁, W₂ to be joined, is connected to the jet nozzles N₁, N₂ via an opening and closing valve 37. Of course, drying gas jet nozzles may be provided separately from the jet nozzles N₁, N₂. An effluent treatment system for discharging and treating the sprayed organic acid liquid L is provided in the cleaning chamber 10, but its details are omitted herein.

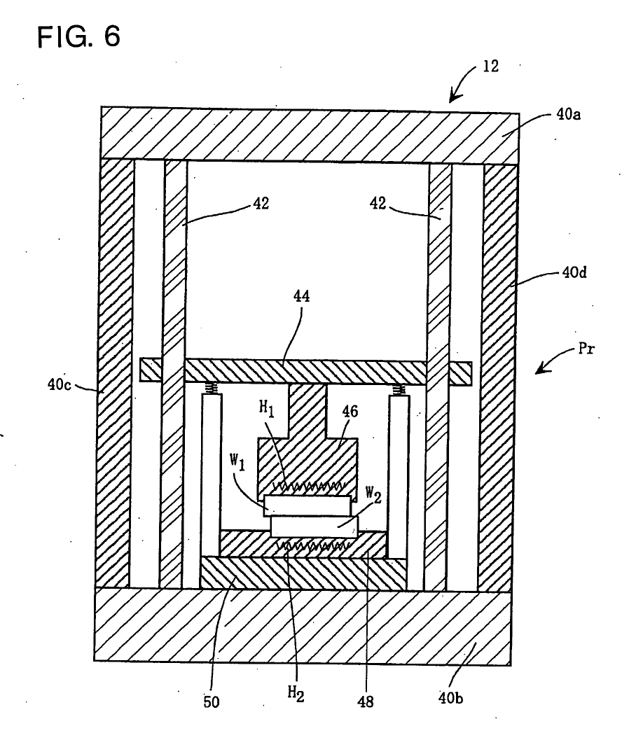

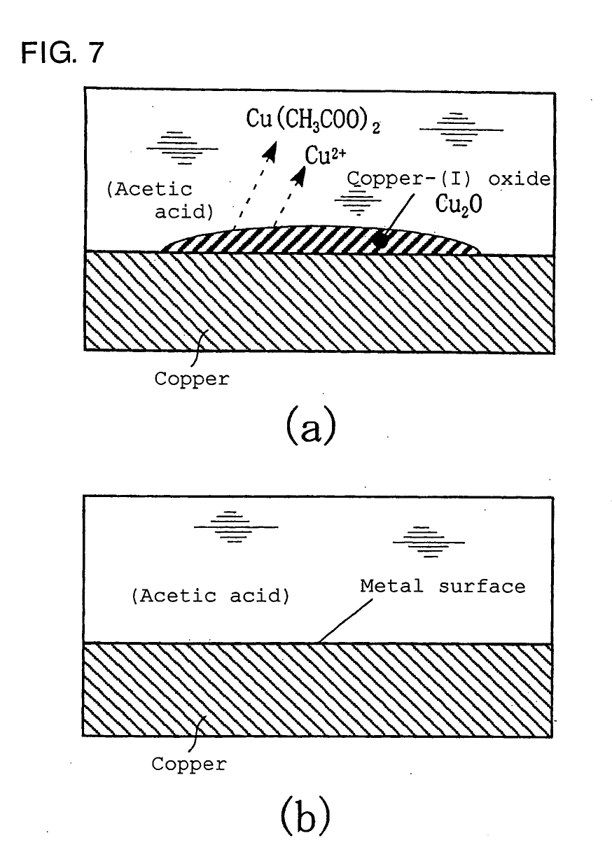

The pressure welding chamber 12 is provided with a pressure welding device Pr as shown in FIG. 6. The pressure welding device Pr has a plurality of threaded shafts 42 extending vertically within a space defined by frames 40a, 40b, 40c, 40d, and a crosshead 44 vertically moving in accordance with the rotations of the threaded shafts 42. Upper and lower mounts 46 and 48 for holding the members W₁, W₂ to be joined are fixed to the crosshead 44 and a base 50, respectively. The crosshead 44 is provided with a load sensor (not shown) for measuring a load imposed.

The mounts 46, 48 are provided with fixing means (not shown), such as clamps or electrostatic chuck, for holding the members W₁, W₂ to be joined, and built-in heaters H₁, H₂ for heating the members W₁, W₂ up to a predetermined temperature. Fixing to the upper mount 46 is performed by vacuum attraction, or electrostatic attraction. The pressure welding chamber 12 is provided with a transfer means, such as a known robot arm, for mounting the members W₁, W₂ to be joined, which have been moved by trolleys or the like as the transport means, onto the mounts 46, 48, and a known positioning means for positioning the members W₁, W₂ to be joined, which have been snapped on the upper and lower mounts 46, 48. However, details of these means are omitted herein.

The method of joining the members W₁, W₂ to be joined, which comprise copper plates, with the use of the joining apparatus of the present embodiment will be described. The members W₁, W₂ to be joined are cleaned and dried beforehand by ordinary methods for removal of deposits on their surfaces, and only the passivation layers ascribed to copper oxide are caused to remain on the surfaces. The two members W₁, W₂ to be joined are placed in the preparatory chamber or the like, mounted on the upper and lower trolleys of the transport means, and carried into the cleaning chamber 10. The atmosphere inside the cleaning chamber 10 is maintained in a predetermined state by the exhaust means 16 and the atmospheric gas supply means 17, whereafter the organic acid liquid L is jetted through the jet nozzles N₁, N₂ and brought into contact with the surfaces of the members W₁, W₂ to be joined.

The use of a carboxylic acid as the organic acid will be described herein. A carboxylic acid reduces and removes an oxide film of copper. This is due to the facts that, as shown in the formulas (4) and (5), this organic acid (acetic acid in this formula) acts on copper ions to form a chelate compound, and the water solubility of this chelate compound (complex) is very high. The following formulas (4) and (5) show the reaction of copper-(I) oxide with acetic acid, and copper-(I) in an acidic environment is disproportionated to form copper-(II) ions and metal copper:
Cu₂O+2CH₃COOH→Cu(CH₃COO)₂⇑+Cu+H₂O (4)
[Cu₂O+2H⁺→Cu²⁺+Cu+H₂O (5)]

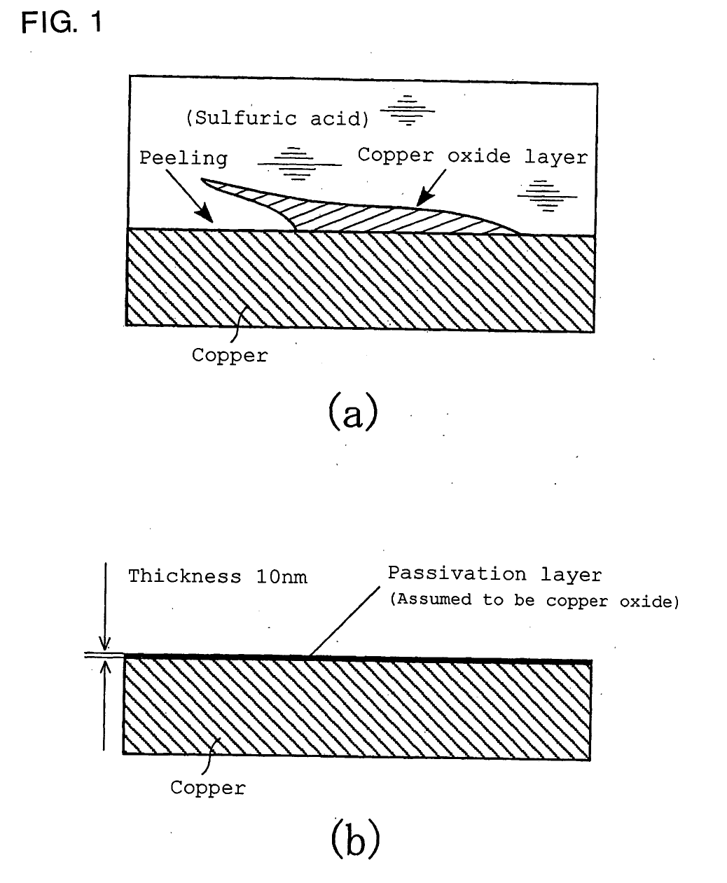

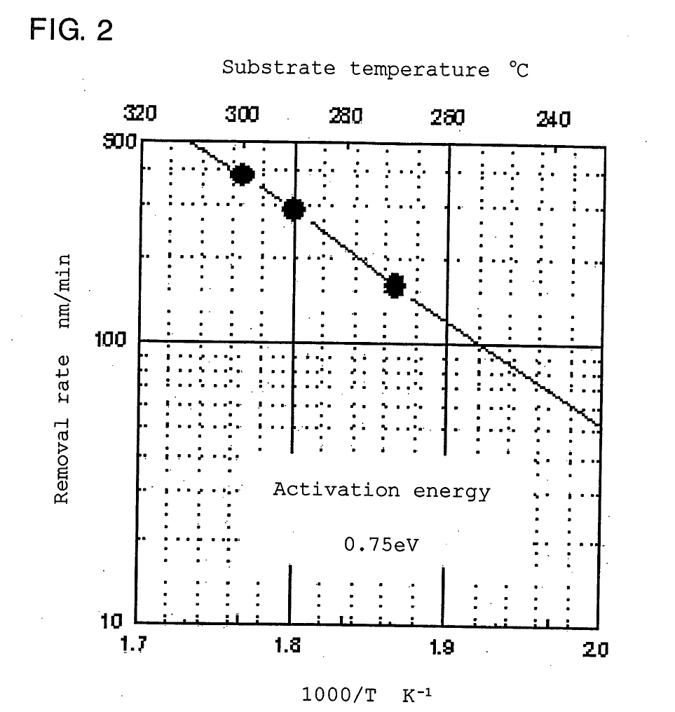

The resulting chelate compound is dissolved into the liquid, as shown in FIG. 7(a), and the copper surface is cleaned. By the reducing action of the organic acid liquid L, the copper surface after cleaning is held in a metallic state, as shown in FIG. 7(b), and the formation of copper oxide can be avoided. As noted here, the function of the organic acid is different from a descaling function by a conventional inorganic acid (the descaling function mainly involves peeling by lift-off; see FIG. 1(a)), and reduces copper oxide to expose a clean metal surface. After drying, a very thin layer of organic acid molecules remains adsorbed onto the metal surface, so that the cleaned metal face is retained for a long term.

Then, a jet of the organic acid liquid L from the jet nozzles N₁, N₂ is stopped, and a drying gas is fed through the drying gas supply piping 36 to dry the surfaces. To remove the remaining organic acid liquid L, the surfaces may be rinsed with pure water or the like before drying. After the atmosphere inside the cleaning chamber 10 is adjusted by the exhaust means 16, the gate 14a is opened, the members W₁, W₂ to be joined are transported into the pressure welding chamber 12 by the transport means, and the members W₁, W₂ to be joined are fixed on the mounts 46, 48 of the pressure welding device Pr in a positioned state by the transfer means or the positioning means. The members W₁, W₂ to be joined are heated to a predetermined temperature (for example, 150° C.) by the heaters H₁, H₂ incorporated with the mounts 46, 48. Then, the actuator of the pressure welding device Pr actuates and applies load on the members W₁, W₂ for a predetermined time at a predetermined contact surface pressure, thereby joining them together.

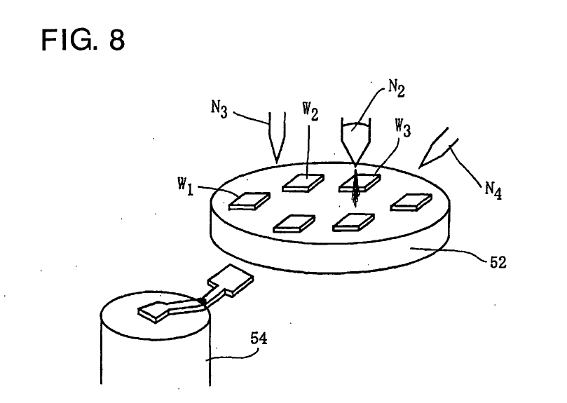

FIG. 8 shows another embodiment of the cleaning chamber 10, revealing like a so-called spin coating device. In this embodiment, the members W₁, W₂, . . . to be joined are set in a circumferential direction on a rotating table 52, and an organic acid liquid jet nozzle N₂, a rinsing water nozzle N₃, and a drying gas nozzle N₄ are disposed sequentially over the rotating table 52. A transfer robot 54 as a transport means can turn over the members W₁, W₂, . . . upside down.

The members W₁, W₂ to be joined, which comprise copper plates, can be joined together, as in the previous embodiment, with the use of the apparatus of this embodiment. In this embodiment, the organic acid liquid L is jetted, with the surfaces to be joined of the members W₁, W₂ to be joined pointing upward. Thus, the organic acid liquid L efficiently acts on the surfaces, and cleans the surfaces uniformly. In this embodiment, the transfer robot 54 as the transport means places and fixes the members W₁, W₂ to be joined, which have finished the cleaning, rinsing and drying, at predetermined positions of the pressure welding device Pr. When the members W₁, W₂ to be joined are to be set on the upper mount 46 of the pressure welding device Pr, the members W₁, W₂ to be joined are turned upside down beforehand, and then mounted and fixed. In this embodiment, the efficiency of the cleaning step is so good that a plurality of the pressure welding chambers 12 may be provided for a single cleaning chamber 10, and the cleaned members W₁, W₂ to be joined may be sequentially supplied.

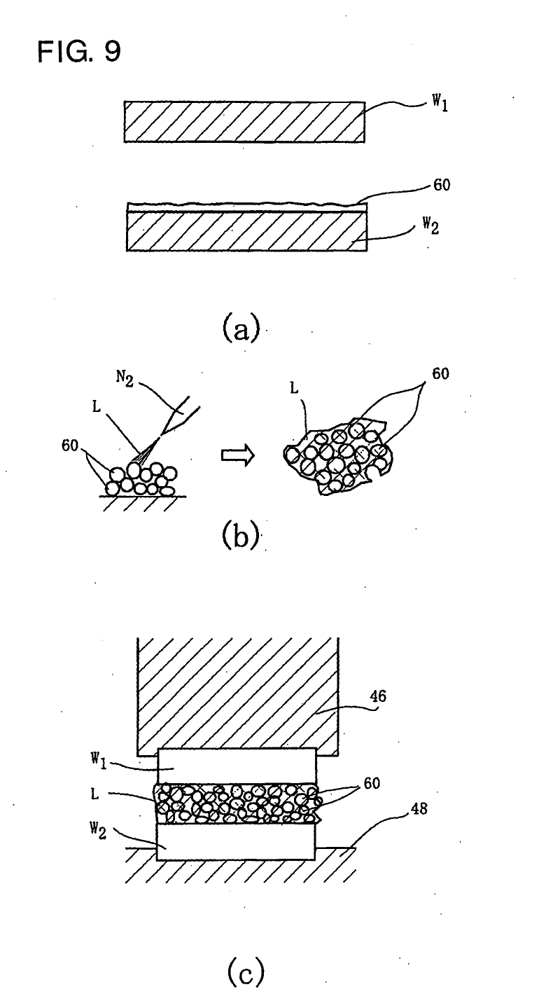

FIGS. 9(a) to 9(c) show the joining method according to another embodiment, illustrating steps in which a different metal-containing material is interposed between the members to be joined. In order to join materials with low joining properties (e.g., aluminum), if they are to be joined in a solid phase, complex nanoparticles such as complex metal nanoparticles 60 are interposed as a different metal-containing material. The complex metal nanoparticles 60 are complex nanoparticles, for example, having a structure in which the surface of a metal core (core) comprising silver or a silver compound is coated with organic matter (namely, the structure is an organic shell).

As shown in FIG. 9(a), the complex metal nanoparticles 60, placed in a suitable amount on the surface of one member W₂ to be joined, are brought into the cleaning chamber 10. As shown in FIG. 9(b), the organic acid liquid L, such as a formic acid liquid, is supplied at a low jet rate from the jet nozzle N₂ to fill the gaps between the complex metal nanoparticles 60 with the organic acid liquid L. The member W₂ bearing the complex metal nanoparticles 60 in this condition is transferred to the lower mount 48 of the pressure welding device Pr of the pressure welding chamber 12. The upper member W₁ to be joined is fixed on the upper mount 46, with the organic acid liquid L being jetted or not being jetted. As in the previous embodiment, the members W₁ and W₂ are heated to a predetermined temperature, and then joined together by pressure welding, as shown in FIG. 9(c).

As described above, complex nanoparticles such as the complex metal nanoparticles 60 are brought into contact with the organic acid, whereby the aforementioned organic shell interacts with the organic acid to promote the decomposition and detachment of the organic shell. On the surfaces of the members W₁, W₂ to be joined, on the other hand, the organic acid reduces the non-metallic substance, such as an oxide, to convert it into a water-soluble complex, thereby removing it and exposing the metal surface. As a result, the surfaces of the members W₁, W₂ to be joined are joined to the complex metal nanoparticles 60 and, at the same time, the nanoparticles are mutually sintered and joined. Consequently, the solid phase joining of the materials essentially having low joining properties is enhanced and promoted with the relatively low heating temperature.

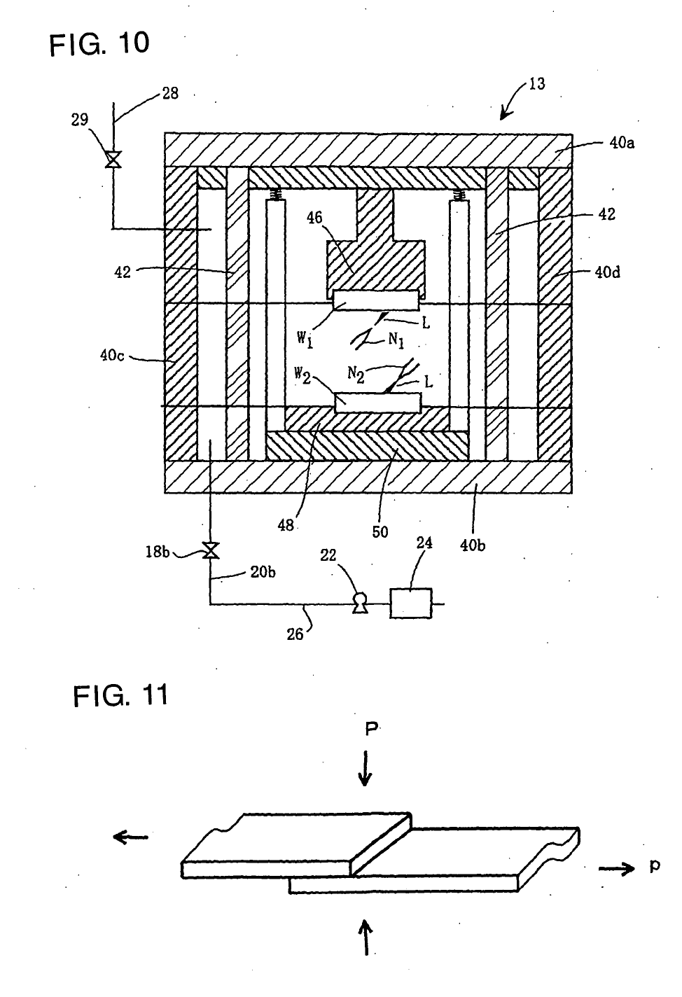

FIG. 10 shows the joining apparatus according to still another embodiment for performing the method of the present invention. This apparatus carries out a cleaning step and a joining step in a single treatment chamber 13. In this joining apparatus, the jet nozzles N₁, N₂ can be disposed so as to be opposed to the mounts 46, 48 of the pressure welding device Pr. The jet nozzles N₁, N₂ can be retreated when the pressure welding device Pr performs a pressure welding action.

With the apparatus of this embodiment, the cleaning step and the joining step are carried out in the single treatment chamber 13, so that a saving in space is achieved, transport means can be omitted, and the working process can be simplified. However, it is necessary to consider a means for suppressing corrosion of the pressure welding device Pr by the organic acid liquid L.

In the above-described embodiments, explanations have been offered for the joining apparatus which has the treatment chamber defining a closed airtight space. However, if the formation of the passivation layer upon exposure to the ordinary air can be neglected, treatment can be performed in the air. Such an apparatus performing treatment in the air is not explained herein, because it is merely any of the apparatuses of the above-mentioned embodiments rendered open to the air.

### EXAMPLE

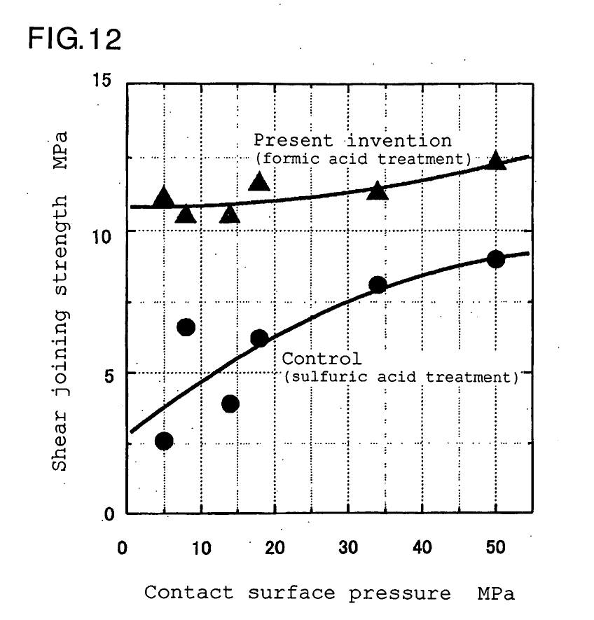

Two 0.6 mm thick copper plates were kept in contact with formic acid as an organic acid for 10 s by use of the apparatus described in FIG. 5, whereby the copper plates were cleaned. Two copper plates with their metal surfaces exposed were used as members W₁, W₂ to be joined, and pressure-welded at a temperature of 120° C., as shown in FIG. 11, to form a lap joint. The pressure welding was performed, with a contact surface pressure P being varied in the range of 5 to 50 MPa. The resulting joint was pulled in longitudinal directions to conduct a shear fracture test. The relationship between the contact surface pressure P and the shear joining strength p is shown in FIG. 12. For comparison, data are also plotted for joined specimens which were prepared by joining under the same conditions, except that sulfuric acid for use in ordinary acid pickling was used as a surface treatment liquid for pretreatment before joining in FIG. 12.

In the Example embodying the present invention, the dependence of the joining strength on the contact surface pressure is very low, and a joining strength of more than 10 MPa is shown even at a slight contact surface pressure of 5 MPa. This may be attributed to the fact that the surfaces of the copper plates immediately before the joining operation are rendered extremely clean by the aforementioned mechanism in the case of the present invention.

With the control, on the other hand, the joining strength is of the order of 9 MPa at the highest. This may be because thin oxide films are formed on the surfaces after acid pickling as stated earlier, whereby contact between the metals is impeded, thus obtaining an imperfect joining state. Furthermore, the joining strength varies greatly according to the contact surface pressure. This may be revelation that a high contact surface pressure is necessary to destroy the oxide films on the surfaces.

### REFERENCE

Akitomo Koide et al., abstracts of lectures at the 47th Applied Physics-Related Joint Lecture Meeting (2000.3) 30 P-YA-16

1. A joining method for bonding together a plurality of members, which are to be joined, in a solid phase state,
comprising a contact step of bringing a liquid organic acid into contact with at least one of surfaces to be joined of the members to be joined, and a step of bringing the surfaces to be joined into contact with each other, thereby joining the members to be joined.

2. The joining method according to claim 1, further comprising interposing a metal-containing material, which is other than a material for the member to be joined, between the members to be joined.

3. The joining method according to claim 1, wherein the member to be joined is a material containing ceramic or plastic, or a composite material containing ceramic or plastic and a metal.

4. The joining method according to claim 2, wherein the member to be joined is a metal, and consists essentially of one or more metals selected from the group consisting of a noble metal, nickel, copper, iron, titanium and aluminum.

5. The joining method according to claim 1, wherein one or more acids selected from the group consisting of succinic acid, malonic acid, phenol, oxalic acid, acetic acid, tartaric acid, citric acid, maleic acid, salicylic acid, formic acid, and other long-chain carboxylic acids is or are used as the organic acid.

6. The joining method according to claim 1, wherein a temperature of the member to be joined in the joining step is rendered 400° C. or lower.

7. The joining method according to claim 1, wherein at least one of materials for the members to be joined is copper or a copper alloy, and the organic acid is formic acid.

8. The joining method according to claim 1, wherein a duration of the contact step is about 1.0 s or more, but less than about 100 s.

9. The joining method according to claim 1, further comprising using any one or more of coating, spraying, jetting, dropwise addition, and printing of the organic acid, and dipping in the organic acid, as a means of bringing the surface of the member to be joined into contact with the organic acid.

10. The joining method according to claim 1, further comprising bringing the organic acid into contact with the plurality of the members to be joined, with the members being held in a predetermined relative positional relationship.

11. The joining method according to claim 1, wherein the organic acid is in a solid phase at a room temperature, and the organic acid is brought into contact with the member to be joined, with the organic acid being dispersed or dissolved in a liquid dispersing medium or solvent, such as alcohol or water.

12. The joining method according to claim 2, wherein the metal-containing material includes nanoparticles.

13. The joining method according to claim 2, wherein the metal-containing material is metal nanoparticles, and the metal nanoparticles are complex nanoparticles having a metal core or metal compound core whose periphery is coated with organic matter.

14. The joining method according to claim 2, wherein the metal-containing material is complex nanoparticles having a core whose periphery is coated with organic matter, and the organic acid is formic acid.

15. A joined structure produced by joining according to the joining method of claim 1.

16. A joining apparatus for metallurgically joining together a plurality of members to be joined, with the members being in a solid phase state, the joining apparatus comprising:
surface cleaning means for bringing a liquid organic acid into contact with surfaces to be joined of the members to be joined; and
joining means for joining the cleaned surfaces to be joined, with the surfaces in contact with each other.
